(19) United States
(12) Patent Application Publication
(10) Pub. No.: US 2022/0318642 A1
(43) Pub. Date: Oct. 6, 2022

(54) METHOD FOR PROVIDING SUPER SELF-MANAGEMENT SERVICE TO PROVIDE STEP-BY-STEP CONSULTING AND MENTORING OF LVH FOR SELF MANAGEMENT

(71) Applicant: SUPERICON INC., Pohang-si (KR)

(72) Inventor: Jae Kwang KIM, Pohang-si (KR)

(21) Appl. No.: 17/252,459

(22) PCT Filed: Aug. 28, 2020
(86) PCT No.: PCT/KR2020/011559

§ 371 Date: Dec. 15, 2020

(30) Foreign Application Priority Data
Aug. 28, 2019 (KR) 10-2019-0106109

(51) Int. Cl. G06N 5/02

(52) U.S. Cl. CPC G06N 5/022; G06Q 50/22

(57) ABSTRACT

There is provided a method for providing a super self-management service to provide step-by-step consulting and mentoring of a life value house (LVH) for self-management, the method executed on a super self-management service providing server, and the method comprising a cornerstone creation step for receiving, from a user terminal, cornerstone data including a mission and core value corresponding to a cornerstone of the LVH and storing the cornerstone data, a pillar creation step for receiving, from the user terminal, pillar data corresponding to health, personal connection, reading, language, and asset corresponding to a pillar of the LVH, an interior creation step for receiving, from the user terminal, differential knowledge, careful planning, bold action, excellent achievements, efficient promotion, and continuous management corresponding to an interior of the LVH, a roof creation step for receiving, from the user terminal, love data corresponding to a roof of the LVH, and a step for automatically generating consulting data by analyzing the data received in the cornerstone, pillar, interior, and roof creation steps and transmitting the consulting data to the user terminal.

### TECHNICAL FIELD

The present invention relates to a method of providing a super self-management service to provide step-by-step consulting and mentoring for LVH for self-management and provides a platform for mentoring and consulting based on per-step data using a metaphor for building a life plan.

### BACKGROUND ART

According to Fluri and Ulrich, management means managing human and material things using social and technical systems with the help of professional methodology. According to the definition of this concept, an independent self-management system that combines and systematizes the professional abilities of others and one's own in order to achieve the task, whether it is an externally added task or a task added by oneself, may be considered part of the management. It is through the domain of behavioral therapy, which attempted to convert to self-control, that self emerged as a social concept. In addition, as a part of this behavioral therapy method, Kanfer's self-managed treatment method with the motto of the value of human freedom is attempted. In the self-management therapy method, the concept of self is expanded to a sense of autonomy as the opposite of others, and the concept of management is expanded to a meaning indicating the behavioral mode in which the actors themselves solve and perform a series of tasks. The ultimate goal of management is to reach oneself, and self-management is to self-plan, control, and achieve this temporal process.

At this time, a platform for life planning for self-management was researched and developed. In this regard, Korean Patent No. 10-0619294 (published on Sep. 1, 2006) and Korean Patent Application Publication No. 10-2011-0064733 (published on Jun. 15, 2011) disclose a configuration for pre-storing a life plan format and information about one or more items, a configuration for receiving a request to create a life plan form from a youth terminal, a configuration in which, when the life plan form including information about one or more predetermined items is transmitted to the youth terminal through a communication network, the item information includes at least one of a view of life, a view of values, a choice of a spouse, a choice of a profession, and a view of a family, a configuration for receiving input information corresponding to information about any item from the youth terminal, setting up to correspond to the item information and generating a life plan, and a configuration for providing a comprehensive life plan, short-, mid-term, and long-term step-by-step goal settings, detailed specific items, and motivation based on a compensation plan according to goal achievement, and a configuration for checking concrete realization on the back side.

However, even if the above-described configurations are used, the user's question about whether or not the life plan was properly set up is not solved because it does not provide the results of analysis for established goas or the results of consulting. Thus, the user ends up practicing the plan with doubts left and is thus not motivated. In addition, as there is no mentor or contents are not timely provided, there is no other choice but to make plans and achieve them without advice or proper guidelines, and this situation is like a ship sails without a lighthouse and it becomes difficult to practice consistently in the same situation. Accordingly, a need arises for developing a platform that may provide contents or communicate with others in addition to systematic life planning.

### DETAILED DESCRIPTION OF THE INVENTION

### Technical Objects

According to an embodiment of the present invention, there may be provided a method for providing a super self-management service to provide step-by-step consulting and mentoring of LVH for self-management, which may divide life planning into a step of cornerstone, a step of pillar, a step of interior, and a step of roof, like the steps of building a house, automatically generates a consulting report based on user data entered in each step and provides the consulting report to the user, adds a mentoring service for providing advice necessary in each step, and providing lecture content required in each step along therewith, thereby removing doubtful circumstances encountered while reaching the goal, providing a role as a lighthouse for a long-term goal via a mentoring service including providing a lecture, allowing mutual goals and agenda to be shared via social media, and hence aiding in motivation and setting up a goal. However, the objects of the embodiments are not limited thereto, and other objects may also be present.

### Means to Achieve Objects

As a technical means to achieve the foregoing technical objects, an embodiment of the present invention includes a cornerstone creation step for receiving, from a user terminal, cornerstone data including a mission and core value corresponding to a cornerstone of a (life value house (LVH) and storing the cornerstone data, a pillar creation step for receiving, from the user terminal, pillar data corresponding to health, personal connection, reading, language, and asset corresponding to a pillar of the LVH, an interior creation step for receiving, from the user terminal, differential knowledge, careful planning, bold action, excellent achievements, efficient promotion, and continuous management corresponding to an interior of the LVH, a roof creation step for receiving, from the user terminal, love data corresponding to a roof of the LVH, and a step for automatically generating consulting data by analyzing the data received in the cornerstone, pillar, interior, and roof creation steps and transmitting the consulting data to the user terminal.

### Effects of the Invention

Any one of the means to achieve the foregoing objects, as described above, may divide life planning into a step of cornerstone, a step of pillar, a step of interior, and a step of roof, like the steps of building a house, automatically generates a consulting report based on user data entered in each step and provides the consulting report to the user, adds a mentoring service for providing advice necessary in each step, and providing lecture content required in each step along therewith, thereby removing doubtful circumstances encountered while reaching the goal, providing a role as a lighthouse for a long-term goal via a mentoring service including providing a lecture, allowing mutual goals and agenda to be shared via social media, and hence aiding in motivation and setting up a goal.

### BRIEF DESCRIPTION OF THE DRAWINGS

FIG. 1 is a view illustrating a system for providing a super self-management service providing step-by-step consulting and mentoring of LVH for self-management according to an embodiment of the present invention;

FIG. 2 is a block diagram illustrating a configuration of a super self-management providing server included in the system of FIG. 1;

FIGS. 3 to 37 are views illustrating an example implementation of a super self-management service providing step-by-step consulting and mentoring of LVH for self-management according to an embodiment of the present invention; and

FIG. 38 is a flowchart illustrating a method for providing a super self-management service to provide step-by-step consulting and mentoring of LVH for self-management according to an embodiment of the present invention.

### MODE TO PRACTICE THE INVENTION

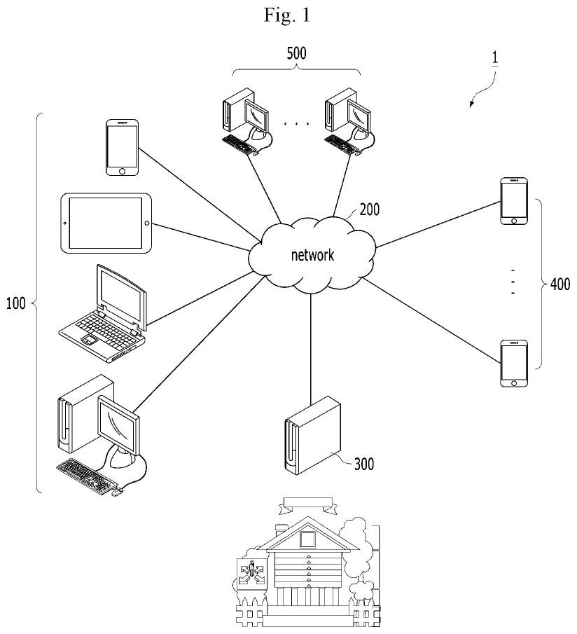

FIG. 1 is a view illustrating a system for providing a super self-management service providing step-by-step consulting and mentoring of LVH for self-management according to an embodiment of the present invention. Referring to FIG. 1, a system 1 for providing a super self-management service to provide step-by-step consulting and mentoring of LVH for self-management may include at least one user terminal 100, a super self-management service providing server 300, at least one mentor terminal 400, and a manager terminal 500. However, the system 1 for providing a super self-management service to provide step-by-step consulting and mentoring of LVH for self-management of FIG. 1 is merely an example and the present invention is not limited thereto.

The components of FIG. 1 are generally connected together via a network 200. For example, referring to FIG. 1, the at least one user terminal 100 may be connected with the super self-management service providing server 300 via the network 200. The super self-management service providing server 300 may be connected with the at least one user terminal 100, at least one mentor terminal 400, and the manager terminal 500 via the network 200. Further, the at least one mentor terminal 400 may be connected with the super self-management service providing server 300 via the network 200. Lastly, the manager terminal 500 may be connected with the user terminal 100, the mentor terminal 400, the super self-management service providing server 300, and at least one manager terminal 500.

Here, the term “network” means a connecting structure to enable exchanging of information between nodes, such as a plurality of terminals and servers. Examples of such network may include, but are not limited to, a radio frequency (RF) network, a 3rd Generation Partnership Project (3GPP) network, a Long Term Evolution (LTE) network, a Long Term Evolution-Advanced (LTE-A) network, a 5th Generation Partnership Project (5GPP) network, a World Interoperability for Microwave Access (WIMAX) network, an Internet network, a Local Area Network (LAN) network, a Wireless LAN network, a Wide Area Network (WAN) network, a Personal Area Network (PAN) network, a Bluetooth network, a satellite broadcast network, an analog broadcast network, and a Digital Multimedia Broadcasting (DMB) network.

As used herein, the singular forms “a,” “an,” and “the” are intended to include the plural forms as well, unless the context clearly indicates otherwise. According to embodiments, a plurality of components of the same type may be a single component of the type, and one component may add one or more components of the same type.

The at least one user terminal 100 may be a terminal that completes a life value house (LVH) for self-management using a webpage, app page, program, or application related to a super self-management service to provide step-by-step consulting and mentoring of LVH for self-management. To this end, at least one user terminal 100 may be a terminal that inputs data required in each stage of life planning compared to building a house. The at least one user terminal 100 may be a terminal that sends a mentor request to the mentor terminal 400 connected through social media or may be a terminal that receives consulting data based on input data. The at least one user terminal 100 may be a terminal that purchases and streams lecture contents recommended for each step. The at least one user terminal 100 may be a terminal that selects a sharee for which information is disclosed and to whom it is fed or may be a terminal that is fed information shared by a sharer.

The at least one user terminal 100 may be implemented as a computer capable of accessing a remote server or terminal via the network. Here, the computer may be, e.g., a navigation or web browser-equipped laptop computer or desktop computer. The at least one user terminal 100 may be implemented as a terminal capable of accessing a remote server or terminal via the network. The at least one user terminal 100 may be, e.g., a portable mobile wireless communication device examples of which may include navigation devices, a Personal Communication System (PCS), Global System for Mobile communications (GSM), Personal Digital Cellular (PDC), Personal Handyphone System (PHS), Personal Digital Assistant (PDA), International Mobile Telecommunication (IMT)-2000, Code Division Multiple Access (CDMA)-2000, W-Code Division Multiple Access (W-CDMA), Wireless Broadband Internet (WiBro) terminal, a smartphone, a smart pad, tablet PC, or any other various types of handheld wireless communication devices.

The super self-management service providing server 300 may be a server to provide a super self-management service webpage, app page, program, or application for providing step-by-step consulting and mentoring of LVH for self-management. The super self-management service providing server 300 may be a server that receives data for each step of LVH from at least one user terminal 100, generates a home-shaped image, resultant from imaging the LVH, for each individual homepage, and displays it. The super self-management service providing server 300 may be a server that generates consulting data based on the information input from the at least one user terminal 100 and provides the consulting data to the at least one user terminal 100. The super self-management service providing server 300 may be a server that analyzes the data input in each step and recommends a mentor or lecture content for the user terminal 100. The super self-management service providing server 300 may be a server that provides a customized life plan and self-management plan to the user terminal 100 based on bigdata. The super self-management service providing server 300 may be a server that stores the mentor-mentee relationship between the user terminals 100 and information feeding relationship of social media and sets up a limit to which information may be shared.

The super self-management service providing server 300 may be implemented as a computer capable of accessing a remote server or terminal via the network. Here, the computer may be, e.g., a navigation or web browser-equipped laptop computer or desktop computer.

The at least one mentor terminal 400 may be a terminal of a mentor using a super self-management service-related webpage, app page, program, or application to provide step-by-step consulting and mentoring of LVH for self-management. The at least one mentor terminal 400 may be a terminal that determines whether to accept a mentor request from at least one user terminal 100 via the super self-management service providing server 300 and transmits the result of determination to the super self-management service providing server 300. Of course, although the at least one mentor terminal 400 may have the same configuration as that of the user terminal 100, the mentor terminal 400 is limited to a role to provide a mentor in description of the embodiments, for ease of description. However, it is apparent that it is not excluded to execute the configuration of the user terminal 100 on at least one mentor terminal 400.

The at least one mentor terminal 400 may be implemented as a computer capable of accessing a remote server or terminal via the network. Here, the computer may be, e.g., a navigation or web browser-equipped laptop computer or desktop computer. The at least one mentor terminal 400 may be implemented as a terminal capable of accessing a remote server or terminal via the network. The at least one mentor terminal 400 may be, e.g., a portable mobile wireless communication device examples of which may include navigation devices, a Personal Communication System (PCS), Global System for Mobile communications (GSM), Personal Digital Cellular (PDC), Personal Handyphone System (PHS), Personal Digital Assistant (PDA), International Mobile Telecommunication (IMT)-2000, Code Division Multiple Access (CDMA)-2000, W-Code Division Multiple Access (W-CDMA), Wireless Broadband Internet (WiBro) terminal, a smartphone, a smart pad, tablet PC, or any other various types of handheld wireless communication devices.

The manager terminal 500 may be a terminal of a manager that manages and maintains the data input from the user terminal 100 using a super self-management service-related webpage, app page, program, or application to provide step-by-step consulting and mentoring of LVH for self-management. The manager terminal 500 may be a terminal that inputs a guideline for the data required to be input in each step to the super self-management service providing server 300 and enables the guideline to be displayed and, when there is advertisement content, divides the advertisement content into target advertisements or normal advertisements and uploads them to the page for each step.

The manager terminal 500 may be implemented as a computer capable of accessing a remote server or terminal via the network. Here, the computer may be, e.g., a navigation or web browser-equipped laptop computer or desktop computer. The manager terminal 500 may be implemented as a terminal capable of accessing a remote server or terminal via the network. The manager terminal 500 may be, e.g., a portable mobile wireless communication device examples of which may include navigation devices, a Personal Communication System (PCS), Global System for Mobile communications (GSM), Personal Digital Cellular (PDC), Personal Handyphone System (PHS), Personal Digital Assistant (PDA), International Mobile Telecommunication (IMT)-2000, Code Division Multiple Access (CDMA)-2000, W-Code Division Multiple Access (W-CDMA), Wireless Broadband Internet (WiBro) terminal, a smartphone, a smart pad, tablet PC, or any other various types of handheld wireless communication devices.

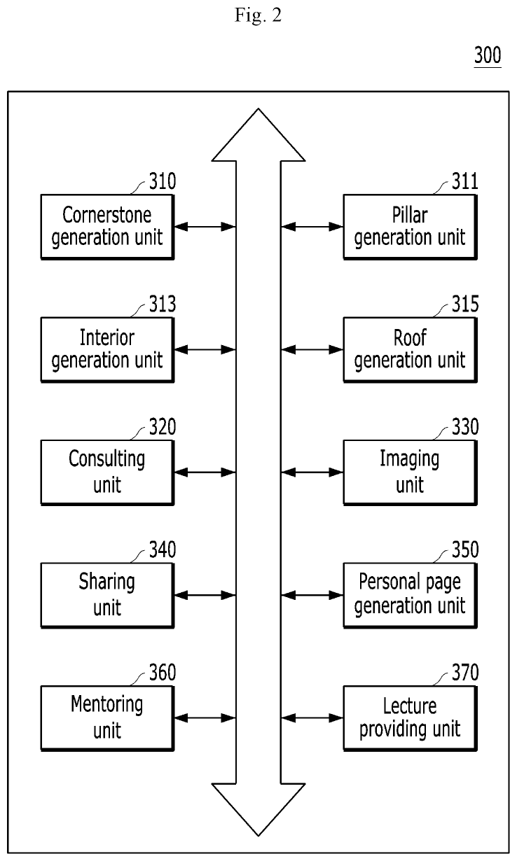

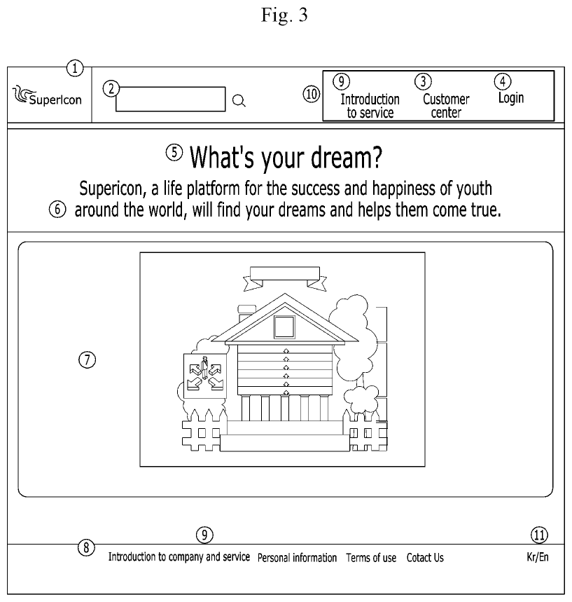

FIG. 2 is a block diagram illustrating a configuration of a super self-management providing server included in the system of FIG. 1. FIG. 3 is a view illustrating an example implementation of a super self-management service providing step-by-step consulting and mentoring of LVH for self-management according to an embodiment of the present invention.

Referring to FIG. 2, the super self-management service providing server 300 may include a cornerstone generation unit 310, a pillar generation unit 311, an interior generation unit 313, a roof generation unit 315, a consulting unit 320, an imaging unit 330, a sharing unit 340, a personal page generation unit 350, a mentoring unit 360, and a lecture providing unit 370.

According to an embodiment of the present invention, when the super self-management service providing server 300 or other server (not shown) operated while interlocking with the super self-management service providing server 300 transmits a super self-management service application, program, app page, or webpage for providing step-by-step consulting and mentoring of LVH for self-management to at least one user terminal 100, at least one mentor terminal 400, and at least one manager terminal 500, the at least one user terminal 100, at least one mentor terminal 400, and at least one manager terminal 500 may install or open the super self-management service application, program, app page, or webpage for providing step-by-step consulting and mentoring of LVH for self-management. Further, a service program may be driven on the at least one user terminal 100, at least one mentor terminal 400, and at least one manager terminal 500 using a script executed on a web browser. Here, the web browser may be a program or application that enables use of world wide web (WWW) services or that receives and shows hypertext written in the hypertext mark-up language (HTML), and the web browser may include, e.g., Netscape, Explorer, or Chrome. The term “application” may mean an application executed on the terminal, and the application may include, e.g., an app running on a mobile terminal, e.g., a smartphone.

Life value house (LVH), which will be described below, is a concept that corresponds to the metaphor to liken life planning to house building, and is expressed as a platform that represents the process of building a cornerstone, building a pillar, decorating the interior, and putting a roof as each stage of life planning and provides consulting and mentoring as to strengths and weaknesses and the direction life should be designed. Each individual user has his or her own homepage, and the content of each life stage entered by the user on his or her homepage is imaged or iconized and expressed in the shape of a house that includes a cornerstone, pillar, interior, and roof for each life planning step. In each step, the data used by the user may be output and disclosed to others. Each individual may visit another's personal homepage, and it is determined whether news may be fed and shared depending on whether they are friends. A mentor may be found and applied for, and the user herself may become a mentor and own mentees. Each component is described based on such concept.

The cornerstone generation unit 310 may receive and store cornerstone data including a mission and core values corresponding to the cornerstone of a Life Value House (LVH) from the user terminal 100. In this case, the core values correspond to my visions. The cornerstone generation unit 310 receives each of the vision (dream), mission, and core values (my credo) and receives the creative part, the part to be removed, the part to be increased, and the part to be decreased in the blue ocean strategy for life to thereby enable SWOT (Strengths, Weaknesses, Opportunities, and Threats)-based consulting.

For life planning, it is necessary to analyze the user's internal strengths and weaknesses, and external opportunities and threats in the external environment. In the contents of LVH, events in which the activity exceeds a preset number or frequency are set as strengths and displayed, and events in which the activity is less than a preset number or frequency is set as weaknesses. The top two items in the list are extracted and set as a strength and weakness respectively. In this case, the score for each area is calculated by classifying it into four areas: cornerstone, pillar, interior, and roof. Thus, as a scoring method, it is identified whether data to be entered for the cornerstone, pillar, interior, and roof is entered, and if entered, e.g., 1 point is given. When an input is made based on whether or not to enter the area of interest for pillar, interior, and roof, whether there is a mentoring activity, and product and service purchase history, 1 point is given. Point giving may occur overlappingly. If it exists in all activities, 1 point may be given and, otherwise, no point is given. By calculating the score for each of these four areas, two areas with high scores may be set as strengths of active activity, and two areas with low scores may be selected as weaknesses with poor activity. Of course, without limitations to the above-described method, point giving may be performed in other various manners, and it is apparent that the way to give a point or the number of points is not limited to the foregoing.

The pillar generation unit 311 may receive pillar data corresponding to the health, personal connections, reading, language, and assets corresponding to the pillars of LVH from the user terminal 100. By receiving the pillar data corresponding to health, personal connections, reading, language, and assets, the pillar generation unit 311 grasps a key point for determining which portions are weaknesses and which portions are strengths, and what content to provide for the weaknesses. For example, health is divided into physical health and mental health, and if it is input that no exercise for a week is entered for the physical health, content or information that encourages exercise is provided. When it is stated that there is depression in mental health, various advice or contents for getting out of depression may be provided. Since this health information is time-synchronized and stored as a history log, it is possible to clearly see what condition the user is in. Personal connection is an input value for mentor-mentee, domestic and overseas social networking information and history management and is a key input value for setting and managing interests and providing lectures and recommended products. Reading is a key input value for managing reading information and history, such as general enhancement and professional knowledge, and setting and managing interests, as well as providing lectures and recommended products, like personal connection. Language is an input value for managing language information and history such as foreign language or communication, and through this, it is possible to set and manage interests and provide lectures and recommended products. Personal asset is an input value for managing asset information, such as safe assets and risky assets, and history and may set and manage interests and provide lectures and recommended products.

A user-customized service is provided based on the above-described data. The user-customized service is to select content based on the user profile and provide an optimized service to the user. In other words, the user-customized service is the process of finding the knowledge and rule to individualize the user's characteristics via various statistical analysis and comparison methods on the user's characteristics. Most of user-customized services require the user's personal information. In the membership registration process, information is obtained through inquiring about personal information or preferences, or information is obtained by analyzing data obtained during the user's activities, such as web visit history or application use history. The user-customized service is frequently used for services for recommending books or music. The user profile may be composed of demographic information such as the user's age, gender, address, etc., and it may be regularized or provided as a service, or a method for recommending a service similar in characteristics to the user's pre-entered preference information or prior-used service or a method for recommending a service preferred by other users with similar propensity to the user. Most of user-customized services (or individual recommendation technology) may configure a user profile and a content profile, calculate the similarity between users, between contents, and between user and content, and provide the optimal service.

In calculating the similarity, a different weight may be given to each piece of information used for similarity calculation, depending on the kind of advertisement content, so that a different user-customized advertisement selection strategy may be established for each advertisement. In other words, for each advertisement content, the optimal advertisement target persons are regularized using the information used in the user profile, and the optimal advertisement (including product or lecture content) may be selected by calculating the similarity between the user profile and the advertisement selection rule. The similarity calculation may be performed based on the following Jaccard similarity, but is not limited thereto, and it is apparent that similarity calculation may also be performed using Pearson Correlation, Cosine Similarity, or Mean Squared Difference (MSD).

The interior generation unit 313 may receive, from the user terminal 100, internal data corresponding to differential knowledge, careful planning, bold action, excellent achievements, efficient promotion, and continuous management corresponding to the interior of the LVH. At this time, when each piece of data is not entered, a preset guidance or tutorial may be provided and, when data is entered, it may be provided along with various services that allow it to continue.

The roof generation unit 315 may receive, from the user terminal 100, love data corresponding to the roof of LVH. The love may provide a comment to encourage the user to keep it consistently when there is an input on social contribution activities, and if there is no such input, recommend a type of volunteer activity that the user may be interested in from the user's data so that the user may perform volunteer activities. This may also be created as a history log, identifying when and in what type the user has been practicing volunteer activities or social contributions in the life time domain.

The consulting unit 320 may analyze the data received in the steps of creating the cornerstone, pillar, interior, and roof, thereby generating automatically consulting data. The consulting data is the same as that described above in connection with the scoring method, and no description thereof is given below.

The imaging unit 330 may receive, from the user terminal 100, the love data corresponding to the roof of LVH in the roof generation unit 315, extract the keyword or icon corresponding to the data received in the steps of creating the cornerstone, pillar, interior, and roof, and overlay it on a home-shaped image of the LVH and output the same on the page of the user terminal 100. In this case, if the world's best composer and persistence of core value are written on the cornerstone, the text, as it is, or as an icon, may be overlaid on the cornerstone part of the house-shaped LVH. Where an icon corresponding to the user-written word text is displayed on the house-shaped LVH, the life planning may be grasped at a glance and intuitively recognized. Of course, it is apparent that other various methods than using an icon may be used to represent the text.

The sharing unit 340 may receive, from the user terminal 100, the love data corresponding to the roof of LVH in the roof generation unit 315 and, then, if a sharing event to request to share on social media occurs from the user terminal 100, the image and content based on the data received in the steps of creating the cornerstone, pillar, interior, and roof may be shared on at least one kind of social media where an account has been created for the user terminal 100. After receiving, from the user terminal 100, the love data corresponding to the roof of LVH in the roof generation unit 315, and when a sharee is selected from the user terminal 100, the sharing unit 340 may share the data entered from the user terminal 100, via a feed of the selected sharee.

The personal page generation unit 350 may receive, from the user terminal 100, the love data corresponding to the roof of LVH in the roof generation unit 315 and generate a personal homepage to allow the image and content based on the data received in the steps of creating the cornerstone, pillar, interior, and roof to be output on the personal page of the user terminal 100. In this case, it may be set based on the data selected from the user terminal 100 whether to disclose the data entered in the steps of creating the cornerstone, pillar, interior, and roof. In this case, since each personal page has been created in the platform according to an embodiment of the present invention, the personal page may be an Internet page residing in the lower layer of the platform.

After receiving, from the user terminal 100, the love data corresponding to the roof of LVH in the roof generation unit 315, and when a request event to request a mentoring service occurs from the user terminal 100, the mentoring unit 360 may transmit the request event to the mentor terminal selected by the user terminal 100. When an accept event to accept the request event from the mentor terminal, the mentoring unit 360 may connect the mentor terminal and the user terminal 100. In this case, the request event may be an event to select, in each step, the mentor terminal classified based on the keyword of the data entered in each step of creating the cornerstone, pillar, interior, and roof. To recommend a mentor or select a mentor based on each keyword, keywords or tags to represent the characteristics of the mentors need to have been set up. Each tag or keyword may correspond to a classification system or classifier, and mentees including the user may do search via such classifications.

The lecture providing unit 370 may receive, from the user terminal 100, the love data corresponding to the roof of LVH in the roof generation unit 315 and then extract a keyword from the data received in the steps of creating the cornerstone, pillar, interior, and roof and extract at least one lecture content corresponding to the extracted keyword. In this case, as described above, the lecture content is the concept included in the mentoring service. The lecture providing unit 370 may transmit at least one lecture content extracted in each step to the user terminal 100 and, when the user terminal 100 selects any one lecture content among the at least one lecture content, the lecture providing unit 370 may output the selected lecture content on the page for each step. To that end, each lecture needs to contain metadata, and a database needs to have been established in which each lecture content and its corresponding metadata have been mapped and stored. The lecture providing unit 370 extracts a keyword from among the words entered from the user terminal 100, grasps the similarity between the keyword or a similar keyword and the pre-stored metadata, and recommends a lecture content for the user terminal 100. This prevents the user from being recommended for a lecture totally irrelevant to the input made by the user.

Further, according to an embodiment of the present invention, it is possible to perform product recommendation and mentoring considering the user's personality. It is hypothesized that there are ones dreaming of becoming an “attorney.” However, each individual, although dreaming of becoming an “attorney,” has a different disposition and personality, the direction to achieve this goal needs to be set differently. In other words, what is considered is that despite the same goal, each one may achieve it in a different way. Personality affects the individual's psychology, emotions, and behavioral characteristics, so that the individual characteristics may be predicted in various areas of life. Accordingly, according to an embodiment of the present invention, the potential personality characteristics of each individual is identified based on a latent profile analysis (LPA) and consulting or mentoring services are provided accordingly. One personality theory is the 5-factor theory (FFT). The 5-factor theory is reported to explain well the characteristics of individual differences in various areas such as life, school, and work. The five factors of personality provide a framework of understanding that may explain the differences in individual emotion, behavior, and cognition. The five-factor personality traits are direct and indirect determinants of behavior and experience. The 5-factor theory of personality may be divided into the structures of neuroticism, extroversion, openness, affinity, and conscientiousness, and the five factors are regarded as being able to predict human thinking, behavior, and emotion.

Neuroticism is a personality trait related to negative emotions such as anxiety, tension, and depression, extroversion is a personality trait related to sociality such as sociality, positive emotions, and assertiveness, openness is a personality trait that is in pursuit of intellectual stimuli such as imagination and curiosity and is open to diversity and new things. Agreeableness is a cooperative and prosocial personality trait such as empathy and altruism, and conscientiousness is related to a personality trait that adheres to diligent and social rules and principles such as self-regulation, responsibility, and achievement-oriented. The five factors of personality are closely related to individual perceptions, emotions, and behaviors such as subjective well-being, depression, achievement goal orientation, self-elasticity, academic exhaustion, and academic achievement. Well-being is a concept related to a positive attribute, and may be divided into subjective well-being (SWB) and psychological well-being (PWB). Subjective well-being refers to the evaluation of happiness in life related to positive and negative emotions and life satisfaction, while psychological well-being has a more complex structure than simply combining positive and negative emotions and life satisfaction and, specifically, means the sum of positive psychologies that contributes to functioning well as a member of the society. This psychological well-being consists of six dimensions: self-acceptance, autonomy, dominance over the environment, purpose of life, personal growth, and positive interpersonal relationships. Psychological well-being affects resilience, organizational commitment, psychological problems, etc. and variables that affect psychological well-being include stress handling strategies and optimism. Personality is also an important predictor of psychological health (well-being). Such individual characteristics and personalities may be reflected and used in consulting. For example, when mentoring or providing consulting services that only give unconditional positive energy to nervous persons, the nervous persons dig into their caves or do not come out and, as a result, avoid use of the application or website. Conversely, if a consulting to have empathy and only touch the inside is provided to extroverts, they may not understand why the application gives such consulting even though they feel ok and thus thinks that the application is irrelevant and is reluctant to use the application. Therefore, consulting is conducted in consideration of each individual's characteristics and propensities, and characteristic information, along with the above-described score calculation, may be used.

Further, according to an embodiment of the present invention, the method may build up bigdata using the data entered from the user terminal 100 as input data. The user data may be classified into structured data, semi-structured data, and unstructured data depending on the structured degree. However, since each item is predetermined, the user data mostly may be classified as the structured data. At this time, raw data including the user data may be stored in parallel and distributed, and pre-processing including classification may be performed thereon using metadata. The pre-processed data may undergone analysis including data mining, and the analyzed data may be visualized and output. Data mining may perform classification to discover internal relations between the processed data pieces and predict a new data class by learning a training data set whose class is known or clustering to group data based on similarity without class information. There may be provided other various types of data mining. Data mining may be performed differently depending on the type of bigdata or the type of query to be made later. The bigdata built up may undergo a verification process by artificial neural network deep learning or mechanical learning.

The artificial neural network may adopt the convolutional neural network (CNN) structure because the CNN has a network structure using the convolution layer, is appropriate for image processing, and may use image data as inputs and classify images based on the features of the images. Text mining is technology for extracting and processing useful information from unstructed/semi-structed text data based on natural language processing technology. Text mining may be used to extract meaningful information from massive data clumps, grasp associations with other information, discover the category of the text, and obtain results more than those by a mere information search. Further, cluster analysis may be used to finally discover groups with similar characteristics by combining objects with similar characteristics.

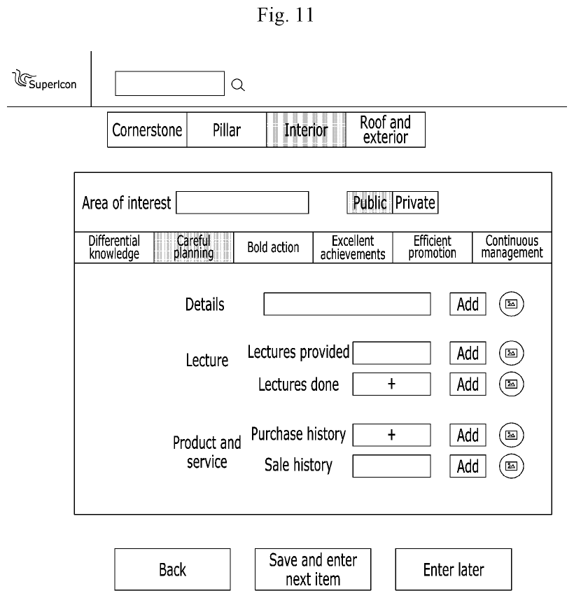

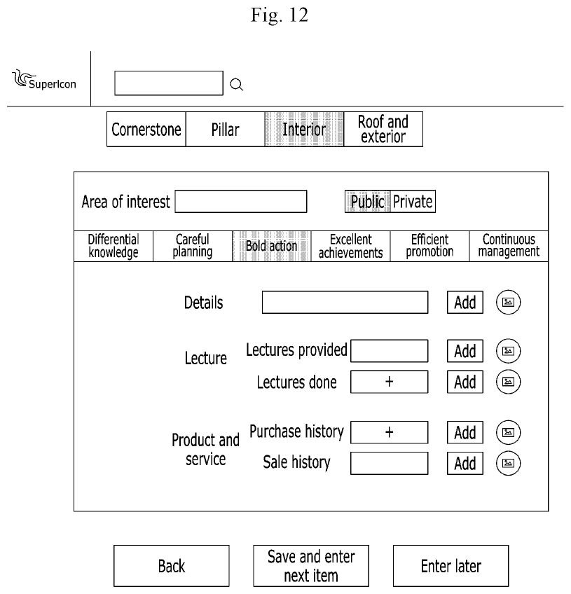

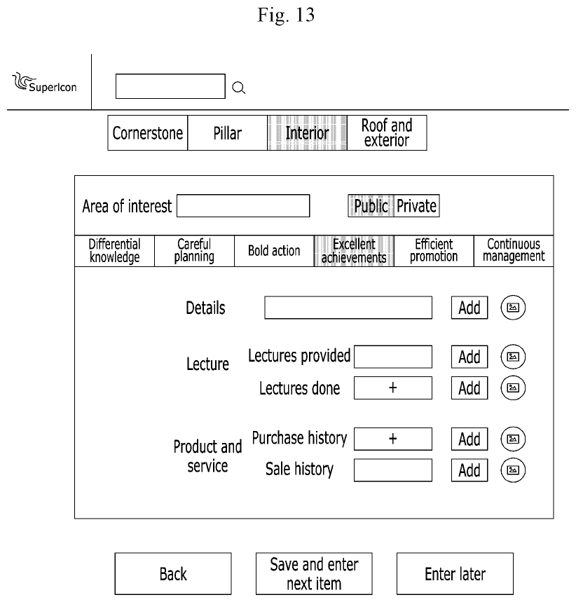

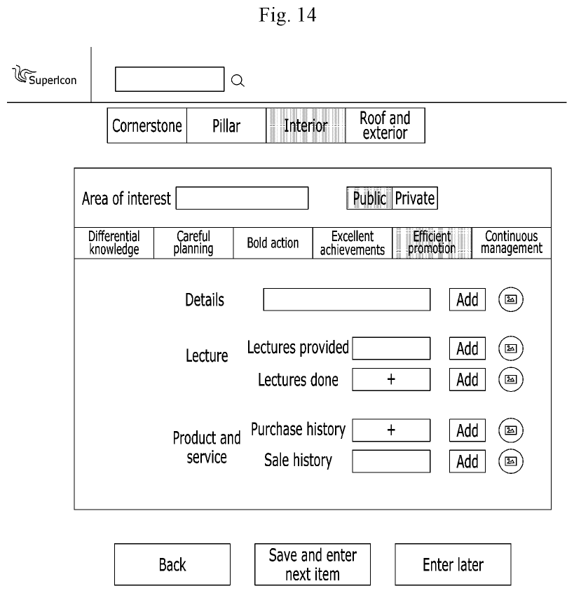

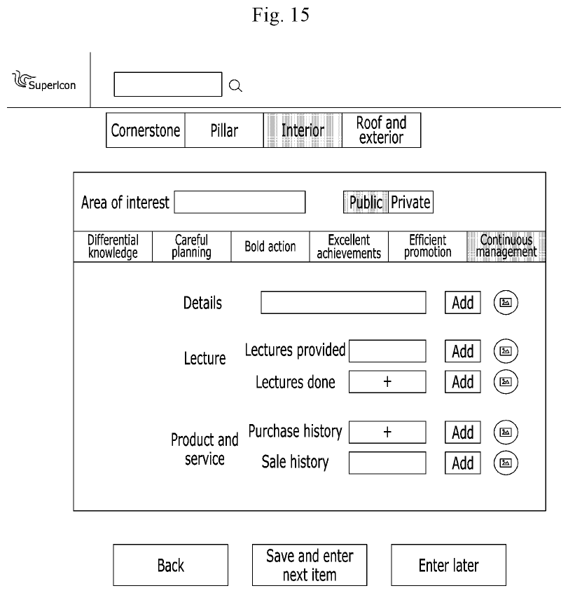

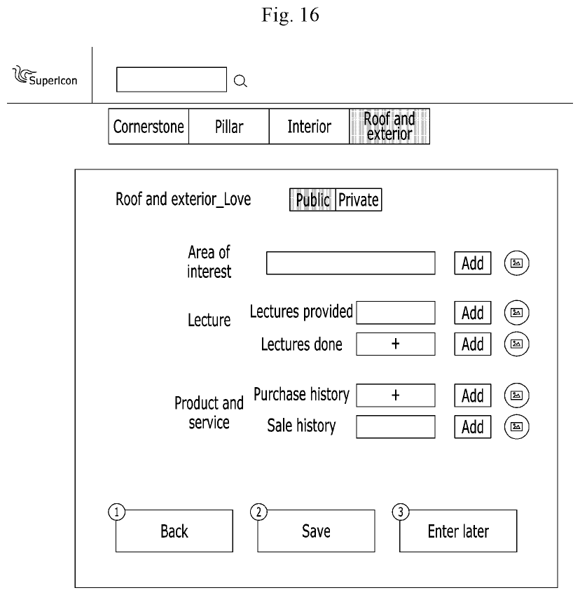

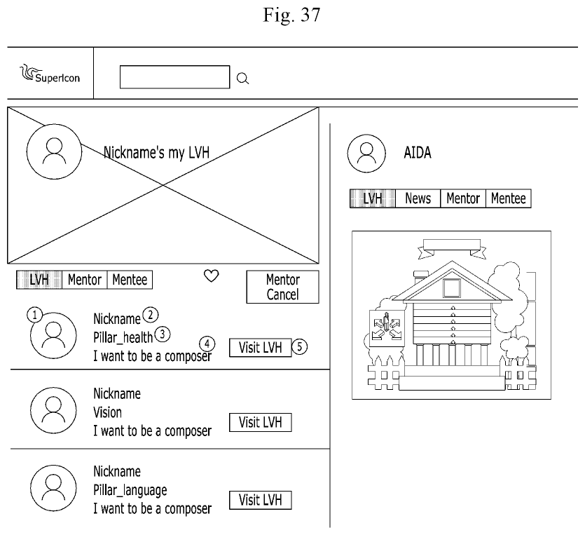

The process of operation by the configuration of the super self-management service providing server of FIG. 2 is described below in detail with reference to FIGS. 3 to 37, for example. However, what is described below is merely an example, and embodiments of the disclosure are not limited thereto.

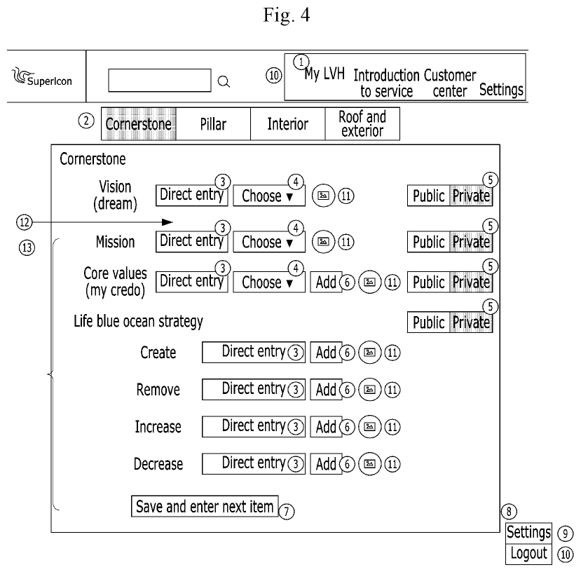

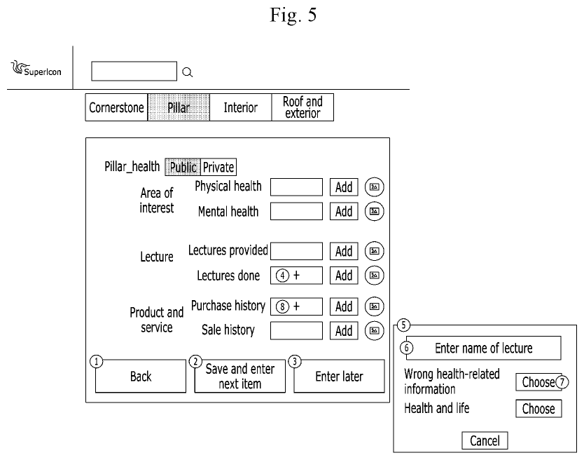

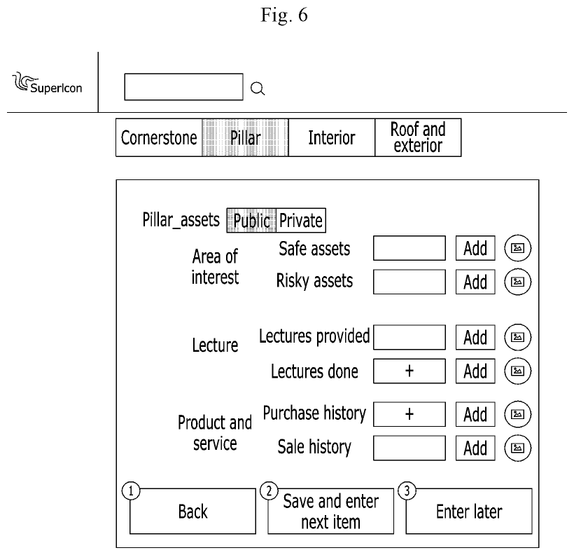

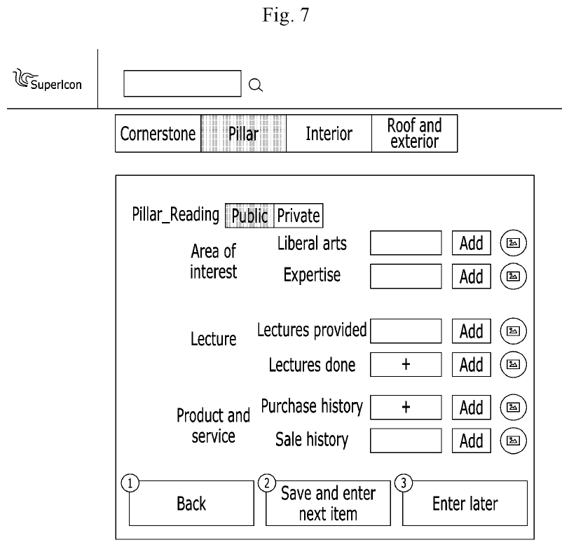

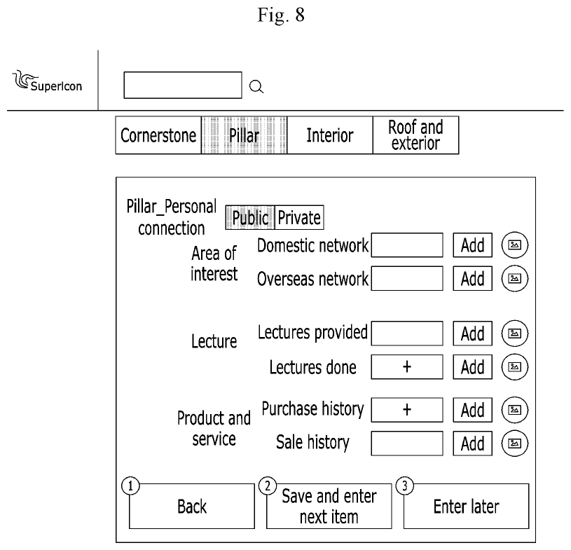

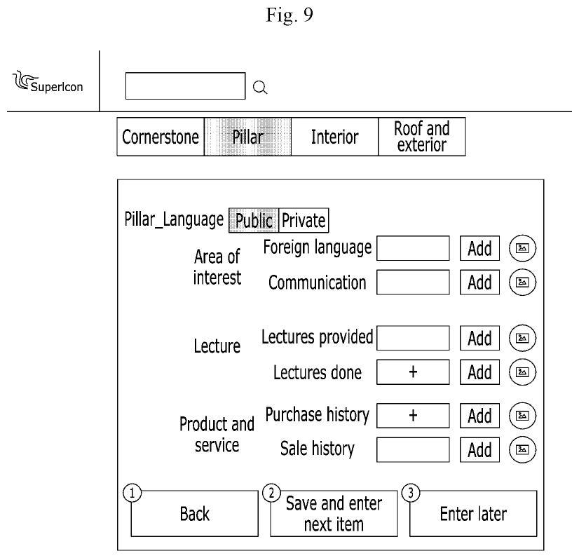

Referring to FIG. 3, an image resultant from forming the LVH into a house shape may be provided to the user terminal 100, and data may be entered in each step of creating the cornerstone through the roof. Although FIG. 4 illustrates an example in which the steps starting with the cornerstone are performed in order as default, the steps may be performed in other order or any one or more steps may be skipped. In this case, in the cornerstone step, the user's vision (dream or goal), mission, core value, or life blue ocean strategy may be entered via a sentence or word. As shown in FIG. 5, the next step is the step of establishing pillars, i.e., receiving pillar data. As the pillars, data corresponding to health as shown in FIG. 5, asset as shown in FIG. 6, reading as shown in FIG. 7, personal connection as shown in FIG. 8, and language as shown in FIG. 9 may be entered and received. The main elements that establish the pillars are configured, by default, as health, assets, reading, personal connection, and language, but it is not excluded that the user may add more elements or delete some. If the step of establishing the pillars for life planning is complete, the next step is to decorate the interior.

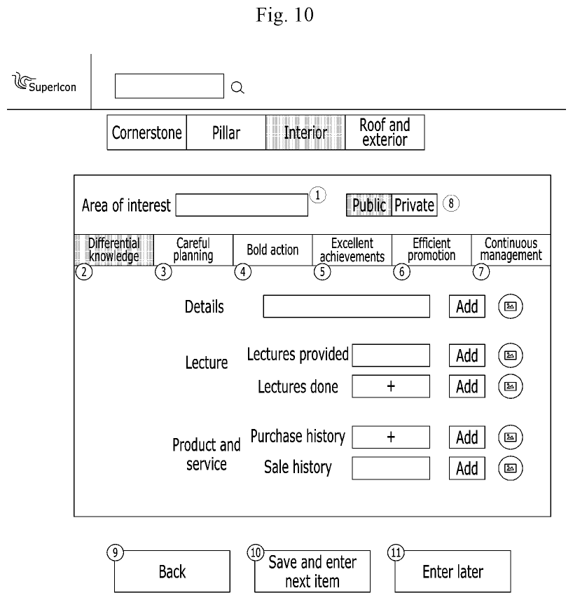

Accordingly, as shown in FIG. 10, what differential knowledge the user has, what is the detailed plan for this, how is the execution done (boldest execution), how does the achievement result from the execution, how the efficient promotion is conducted, and how the steady management is carried out may be received. Of course, it is not excluded to skip any one or more steps, deleting some, or adding more like in the pillar establishing step. In proceeding with the step of putting the roof (roof and exterior), information about the degree of social contributions or the user's love relationship may be received. If the user decides to divorce and the relationship with the spouse reaches the point of breakdown, the platform of the present invention may select, and provide the user, with content to solve this problem or a product to calm down or relax the mind.

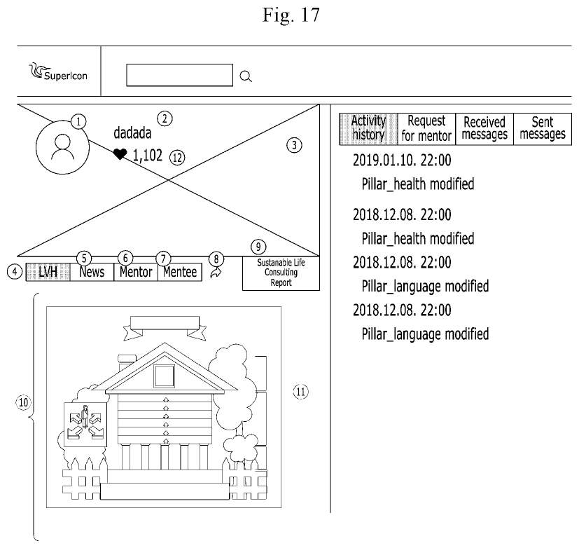

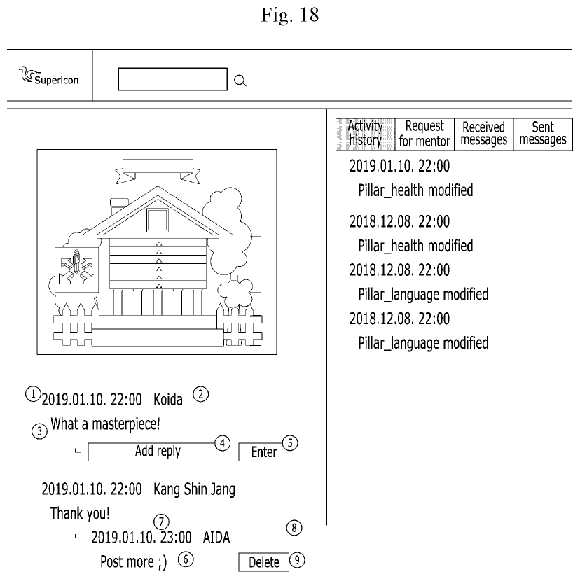

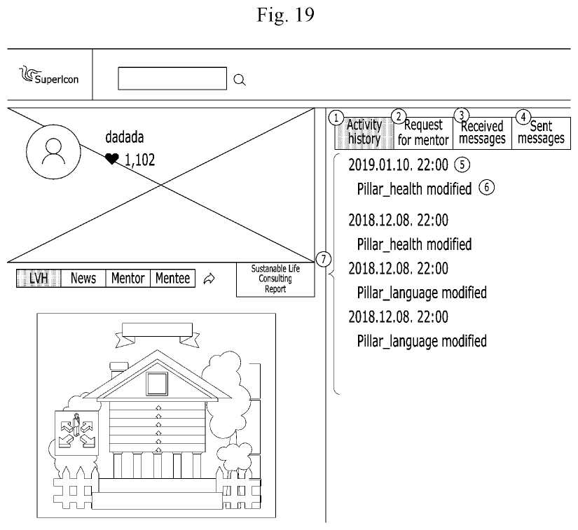

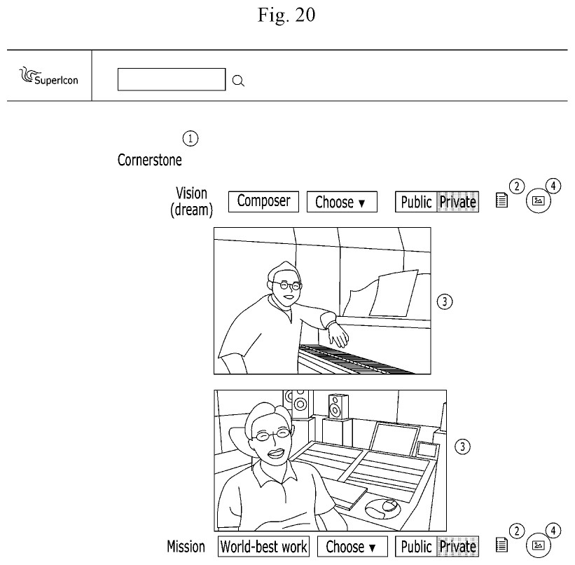

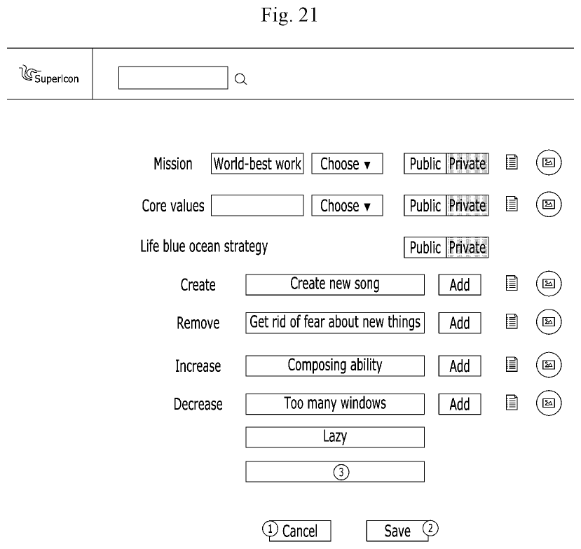

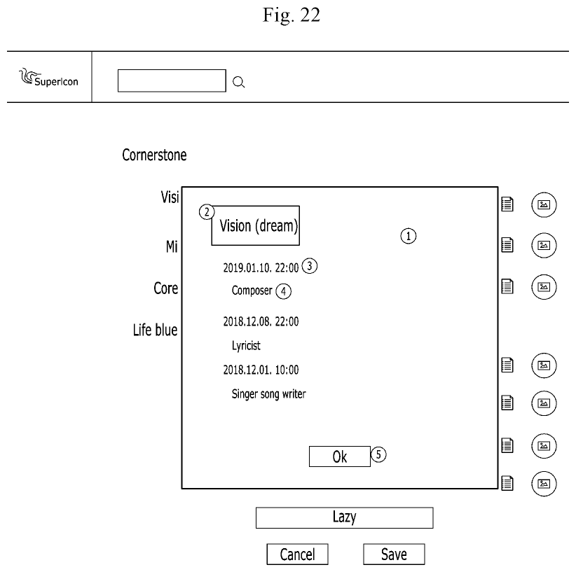

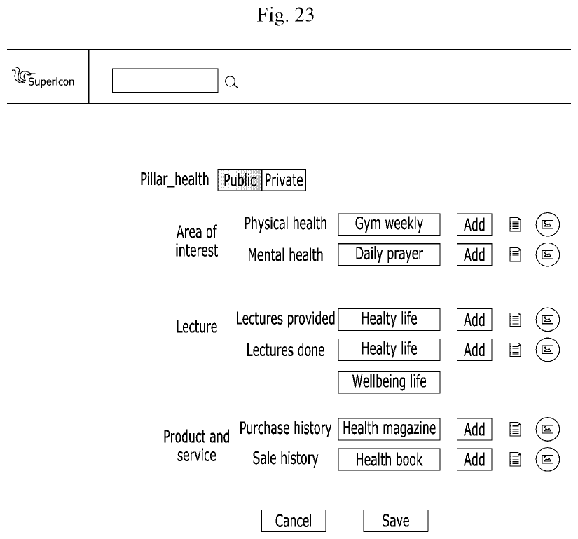

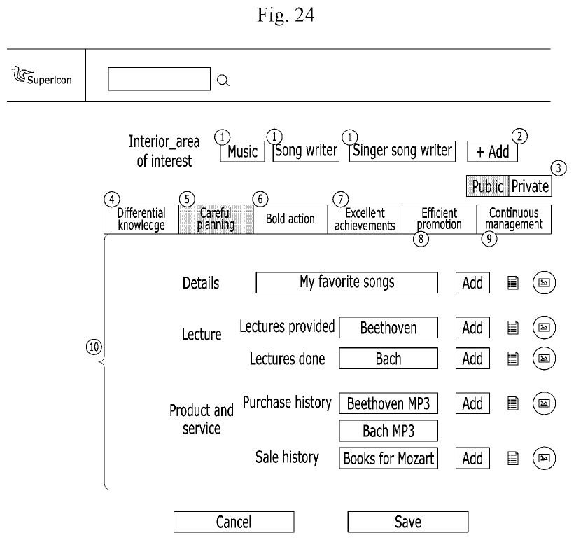

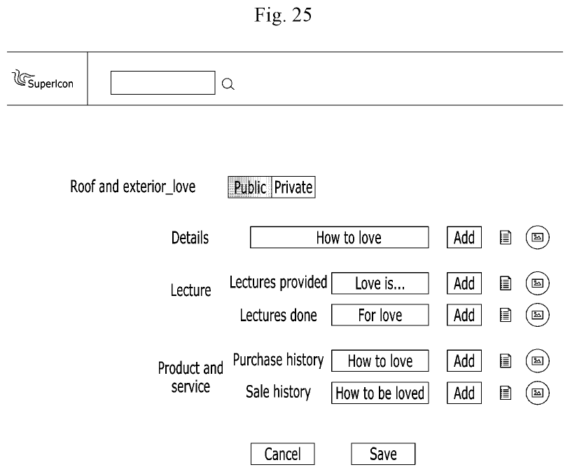

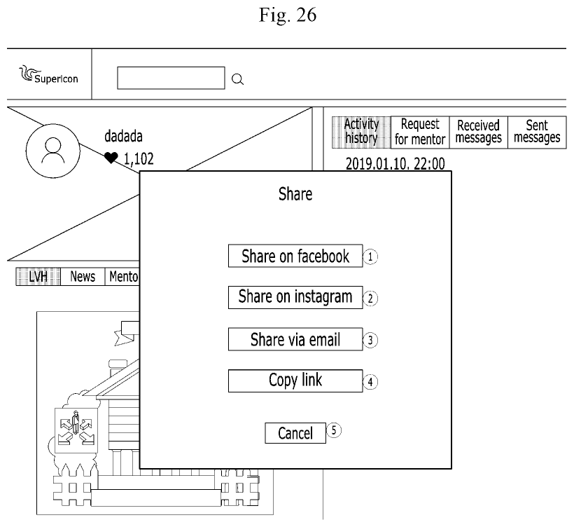

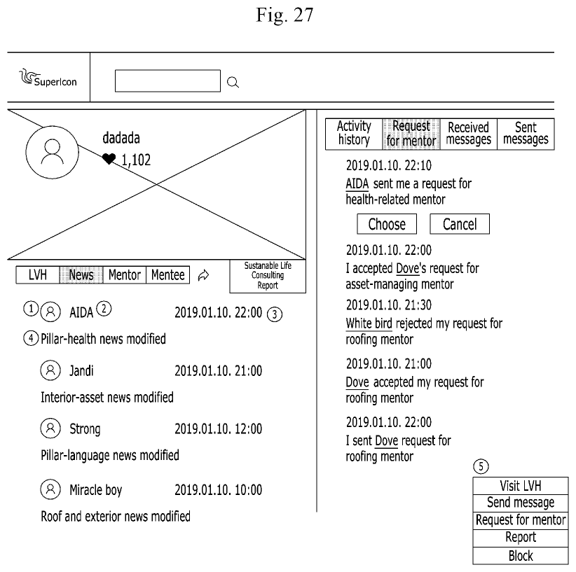

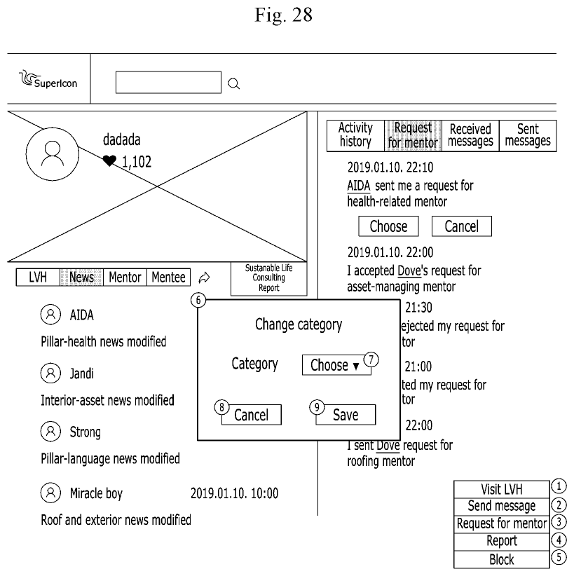

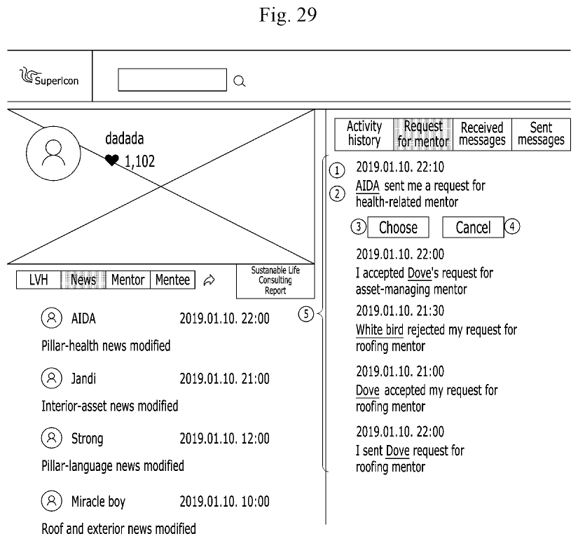

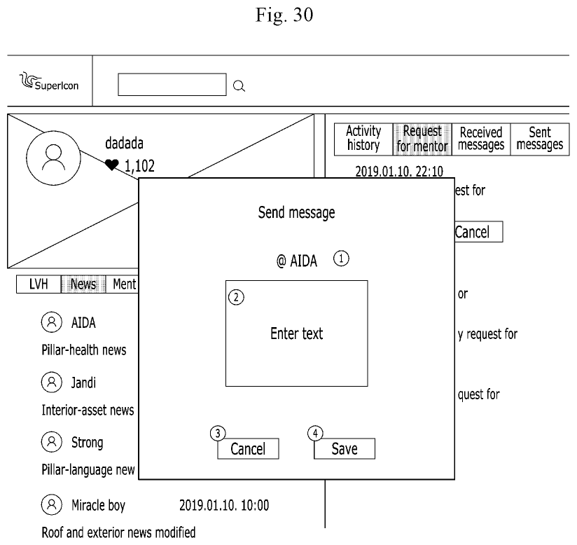

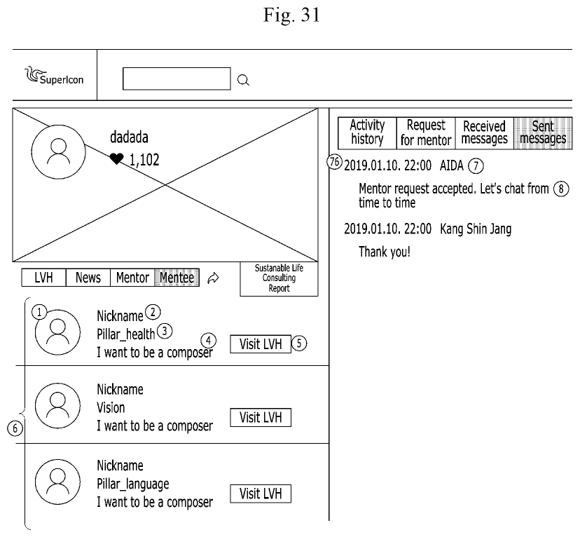

When entry of the data in each step is complete, a complete home image composed of the data entered by the user is displayed on the personal homepage as shown in FIG. 17. In the activity history, the information entered or modified by the user may be displayed as a history log and, as shown in FIG. 18, others' replies may also be output on the main page. As shown in FIG. 19, the activity history may be output in year/month/day/hour/minute, and only the modified text data of LVH may be exposed in order from latest. Referring to FIG. 20, when the cornerstone is clicked, the pre-entered content may be displayed, and the image may be uploaded directly by the user, and the platform itself may select a role model corresponding to the user's dream, and photos of the role model may be uploaded. Referring to FIG. 21, a range of disclosure, such as to everyone, none, or friends, for the data of each of the life blue ocean strategy, core values, and mission may be set and, as shown in FIG. 22, the history in which the vision has changed may be listed up. Referring to FIGS. 23 and 24, the areas of interest may be added or deleted in the format of a tag, and a recommended lecture may be uploaded. Referring to FIG. 25, the state in which a lecture, product, or service has been recommended may be displayed. The so-complete personal homepage or the LVH itself may be shared as shown in FIG. 26 or a mentor-mentee relationship may be formed as shown in FIG. 27. When a mentor is requested, a search may be done via the category classification as shown in FIG. 28 and, as shown in FIG. 29, the request for a mentor may be accepted or rejected and the user, as the mentee, may let others know the result of the request. As shown in FIG. 30, a message may be sent between individuals, or a list of received and sent messages may be sorted and listed up in order from latest as shown in FIG. 31.

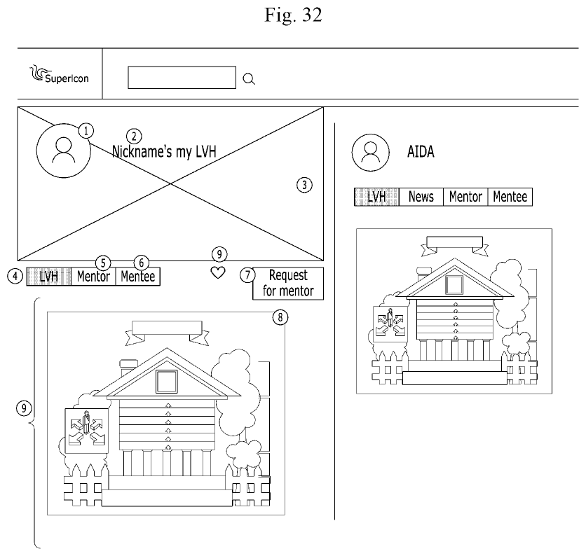

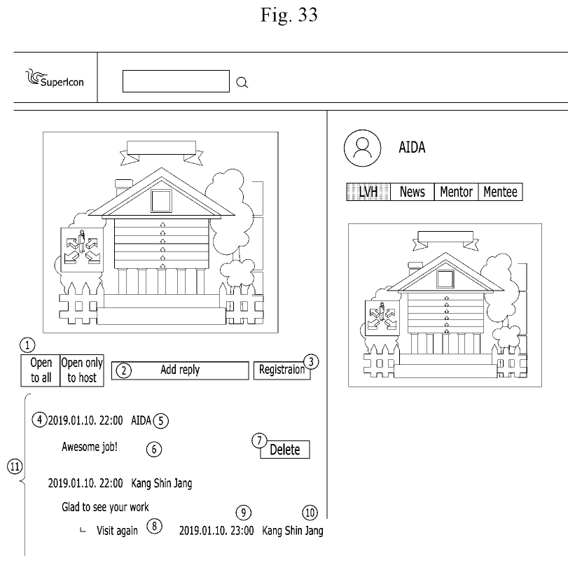

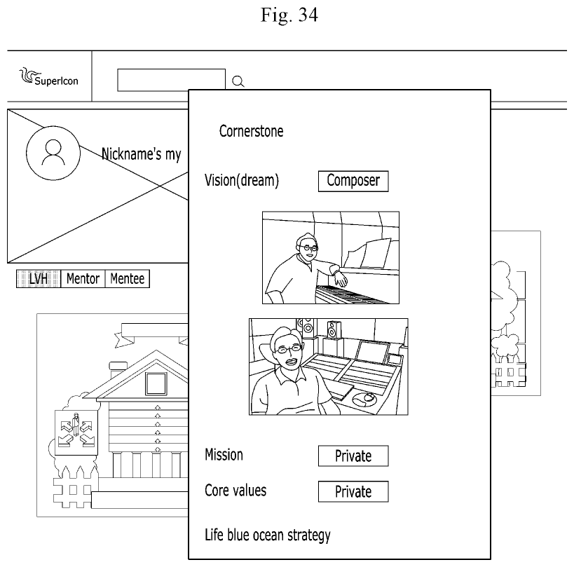

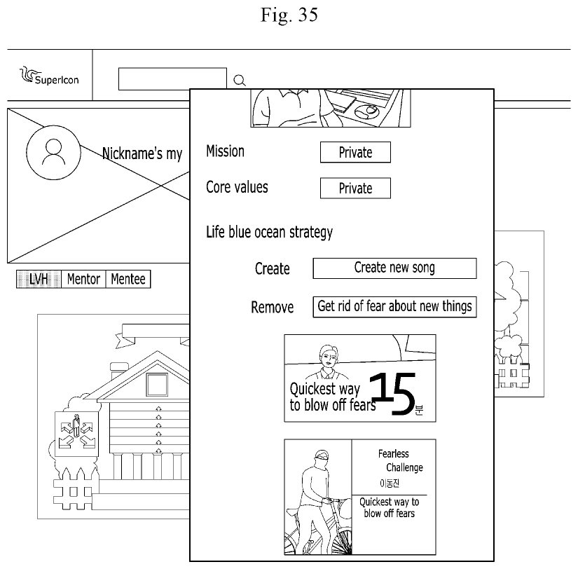

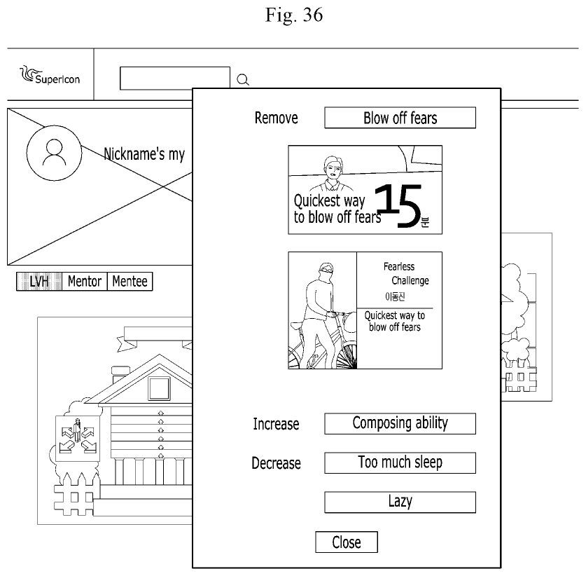

As shown in FIG. 32, the user may look at the LVH on another person's page and, as shown in FIG. 33, the user may look at the replies on the other person's page. Depending on whether public or private, the user may look at the cornerstone and role model as shown in FIG. 34. As shown in FIGS. 35 and 36, the user may search for or share the information about the other person's goal depending on whether public or private, such as the other person's strengths, weaknesses, and the characteristics to be removed.

What is not described regarding the method for providing a super self-management service to provide step-by-step consulting and mentoring of LVH for self-management in connection with FIGS. 2 to 4 is the same or easily inferred from what has been described regarding the method for providing a super self-management service to provide step-by-step consulting and mentoring of LVH for self-management in connection with FIG. 1, and no detailed description thereof is thus presented.

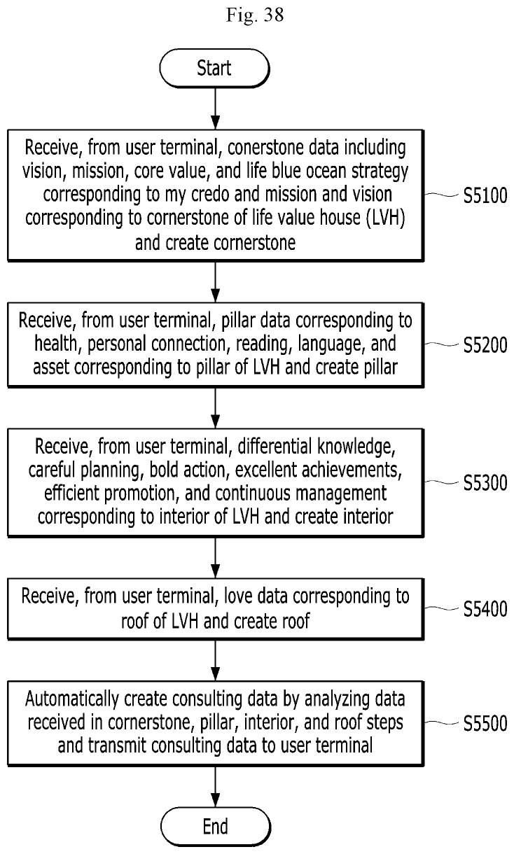

FIG. 38 is a flowchart illustrating a method for providing a super self-management service to provide step-by-step consulting and mentoring of LVH for self-management according to an embodiment of the present invention. Referring to FIG. 38, the super self-management service providing server receives, from the user terminal, and stores the cornerstone data including the mission and vision corresponding to the cornerstone of the life value house (LVH), and the vision, mission, core value, and life blue ocean strategy corresponding to my credo (S5100).

The super self-management service providing server receives pillar data corresponding to the health, personal connection, reading, language, and assets corresponding to the pillars of the LVH from the user terminal (S5200), and the super self-management service providing server receives interior data corresponding to differential knowledge, careful planning, bold action, excellent achievements, efficient promotion, and continuous management corresponding to the interior of the LVH (S5300).

The super self-management service providing server receives the love data corresponding to the roof of the LVH from the user terminal (S5400), automatically generates consulting data by analyzing the data received in the steps of creating the cornerstone, pillar, interior, and roof, and transmits the consulting data to the user terminal (S5500).

The above-described steps S5100 to S5500 are merely an example, and embodiments of the disclosure are not limited thereto. In other words, the above-described steps S5100 to S5500 may be performed in a different order, or some of the steps may be simultaneously performed or omitted.

What is not described regarding the method for providing a super self-management service to provide step-by-step consulting and mentoring of LVH for self-management in connection with FIG. 38 is the same or easily inferred from what has been described regarding the method for providing a super self-management service to provide step-by-step consulting and mentoring of LVH for self-management in connection with FIGS. 1 to 37, and no detailed description thereof is thus presented.

The method for providing a super self-management service to provide step-by-step consulting and mentoring of LVH for self-management, according to an embodiment, described with reference to FIG. 38 may be implemented in the form of a recording medium or computer-readable medium containing computer-executable instructions or commands, such as an application or program module executable on a computer. The computer-readable medium may be an available medium that is accessible by a computer. The computer-readable storage medium may include a volatile medium, a non-volatile medium, a separable medium, and/or an inseparable medium. The computer-readable medium may include a computer storage medium. The computer storage medium may include a volatile medium, a non-volatile medium, a separable medium, and/or an inseparable medium that is implemented in any method or scheme to store computer-readable commands, data architecture, program modules, or other data or information.

According to an embodiment, the above-described method for providing a super self-management service to provide step-by-step consulting and mentoring of LVH for self-management may be executed by an application installed on a terminal, including a platform equipped in the terminal or a program included in the operating system of the terminal), or may be executed by an application (or program) installed by the user on a master terminal via an application providing server, such as a web server, associated with the service or method, an application, or an application store server. According to an embodiment, the above-described method for providing a super self-management service to provide step-by-step consulting and mentoring of LVH for self-management may be implemented in an application or program installed as default on the terminal or installed directly by the user and may be recorded in a recording medium or storage medium readable by a terminal or computer.

What is claimed is:

1. A method for providing a super self-management service to provide step-by-step consulting and mentoring of a life value house (LVH) for self-management, the method executed on a super self-management service providing server, and the method comprising:
a cornerstone creation step for receiving, from a user terminal, cornerstone data including a mission and core value corresponding to a cornerstone of the LVH and storing the cornerstone data;
a pillar creation step for receiving, from the user terminal, pillar data corresponding to health, personal connection, reading, language, and asset corresponding to a pillar of the LVH;
an interior creation step for receiving, from the user terminal, differential knowledge, careful planning, bold action, excellent achievements, efficient promotion, and continuous management corresponding to an interior of the LVH;
a roof creation step for receiving, from the user terminal, love data corresponding to a roof of the LVH; and
a step for automatically generating consulting data by analyzing the data received in the cornerstone, pillar, interior, and roof creation steps and transmitting the consulting data to the user terminal.

2. The method of claim 1, further comprising, after the roof creation step for receiving, form the user terminal, the love data corresponding to the roof of the LVH, extracting a keyword or icon corresponding to the data received in the cornerstone, pillar, interior, and roof creation steps, overlaying the keyword or icon on a house-shaped image of the LVH, and outputting the keyword or icon and the home-shaped image of the LVH on a page of the user terminal.

3. The method of claim 1, further comprising, after the roof creation step for receiving, from the user terminal, the love data corresponding to the roof of the LVH, sharing an image and content based on the data received in the cornerstone, pillar, interior, and roof creation steps on at least one kind of social media where an account of the user terminal has been generated when a sharing event to request to share on social media occurs from the user terminal.

4. The method of claim 1, further comprising, after the roof creation step for receiving, from the user terminal, the love data corresponding to the roof of the LVH, creating a personal homepage of the user terminal to allow an image and content based on the data received in the cornerstone, pillar, interior, and roof creation steps to be output on the personal homepage, wherein whether to disclose the data entered in the cornerstone, pillar, interior, and roof creation steps is set based on data selected by the user terminal.

5. The method of claim 1, further comprising, after the roof creation step for receiving, from the user terminal, the love data corresponding to the roof of the LVH, transmitting a request event to a mentor terminal selected by the user terminal when the request event to request a mentoring service occurs from the user terminal; and connecting the mentor terminal and the user terminal when an accept event to accept the request event occurs from the mentor terminal.

6. The method of claim 5, wherein the request event is an event to stepwise select the mentor terminal classified based on a keyword of the data entered in each of the cornerstone, pillar, interior, and roof creation steps.

7. The method of claim 1, further comprising, after the roof creation step for receiving, from the user terminal, the love data corresponding to the roof of the LVH, sharing data entered from the user terminal via a feed of a sharee when the sharee is selected from the user terminal.
